(19) United States
(12) Patent Application Publication
(10) Pub. No.: US 2020/0045507 A1
(43) Pub. Date: Feb. 6, 2020

(54) COMMUNICATION SYSTEM, METHOD AND COORDINATION ENTITY FOR MULTIMEDIA BROADCAST/MULTICAST SERVICE

(71) Applicant: Institute For Information Industry, Taipei (TW)

(72) Inventors: Chun-Yen HSU, Taipei City (TW); Ting-Yi CHU, New Taipei City (TW)

(21) Appl. No.: 16/173,891

(22) Filed: Oct. 29, 2018

(30) Foreign Application Priority Data
Aug. 2, 2018 (TW) 107126894

(51) Int. Cl. H04W 4/06

(52) U.S. Cl. CPC H04W 4/06; H04W 84/042

(57) ABSTRACT

A multimedia broadcast/multicast service (MBMS) coordination entity commands a first base station and a second base station to establish an MBMS control plane such that the second base station receives MBMS control signals from a core network on the MBMS control plane. The MBMS coordination entity also commands the first base station and the second base station to establish an MBMS user plane or commands the second base station to establish an MBMS user plane with the core network, such that the second station receives MBMS data from the core network on the MBMS user plane.

### PRIORITY

This application claims priority to Taiwan Patent Application No. 107126894 filed on Aug. 2, 2018, which is hereby incorporated by reference in its entirety.

### FIELD

The present invention relates to a communication system and a communication method. More particularly, the present invention relates to a communication system in support of multimedia broadcast/multicast service (MBMS), a method providing the MBMS and an MBMS coordination entity.

### BACKGROUND

As the development of the 4th generation mobile communication systems steps into maturity, international standards organizations, such as International Telecommunication Union (ITU), 3rd Generation Partnership Project (3GPP), 5th Generation Infrastructure Public-Private Partnership (5G PPP), are actively involved in the development of standards for 5th generation wireless communication systems. Compared to the 4th generation mobile communication systems, the 5th generation mobile communication systems have the following prospects: faster transmission speed, better transmission quality, higher signal coverage, more common networking environment, and so on.

Before the standardization of the standalone 5th generation mobile communication system (5G SA) is finalized, the non-standalone 5th generation mobile communication system (5G NSA) is a transitional solution. The non-standalone 5th generation mobile communication system is a mobile communication system which may be operated under the architectures of the base station of the 4th generation mobile communication system (eNodeB) and the base station of the 5th generation mobile communication system (gNodeB) existing simultaneously. In order to implement the non-standalone 5th generation mobile communication system, the existing architecture of the 4th generation mobile communication system has to be changed. It will be a problem as to how to maintain the original services provided by the 4th generation mobile communication system once the architecture of the 4th generation mobile communication system is changed.

For example, under the existing architecture of the 4th generation mobile communication system, the base stations of the 4th generation mobile communication system can provide multimedia broadcast/multicast service (MBMS). However, there is an unsolved problem in the art regarding whether both of the base station of the 4th generation mobile communication system (eNodeB) and the base station of the 5th generation mobile communication system (gNodeB) are able to provide the MBMS under the non-standalone 5th generation mobile communication system.

In the light of this, it is important to make the non-standalone 5th generation mobile communication system capable of providing the MBMS.

### SUMMARY

To solve at least the aforesaid problem, certain embodiments provide a communication system in support of multimedia broadcast/multicast service (MBMS). The communication system may include a core network, an MBMS coordination entity, a first base station and a second base station. The MBMS coordination entity may be coupled to the core network and the first base station. The MBMS coordination entity may command a first base station and a second base station to establish an MBMS control plane such that the second base station receives MBMS control signals from a core network on the MBMS control plane. Furthermore, the MBMS coordination entity may also command the first base station and the second base station to establish an MBMS user plane or command the second base station to establish an MBMS user plane with the core network, such that the second station receives MBMS data from the core network on the MBMS user plane.

To solve at least the aforesaid problem, certain embodiments provide a method providing MBMS. The method may comprise:

commanding, by an MBMS coordination entity, a first base station and a second base station to establish an MBMS control plane such that the second base station receives MBMS control signals from a core network on the MBMS control plane; and

commanding the first base station and the second base station to establish an MBMS user plane by the MBMS coordination entity or commanding the second base station to establish an MBMS user plane with the core network by the MBMS coordination entity, such that the second base station receives MBMS data from the core network on the MBMS user plane.

To solve at least the aforesaid problem, certain embodiments may provide an MBMS coordination entity. The MBMS coordination entity may comprise a transceiver and a processor which is electrically connected to the transceiver. The transmitter may be coupled to a core network and a first base station. The processor may be configured to: command the first base station and a second base station to establish an MBMS control plane such that the second base station receives MBMS control signals from the core network on the MBMS control plane; and command the first base station and the second base station to establish an MBMS user plane or command the second base station to establish an MBMS user plane with the core network, such that the second base station receives MBMS data from the core network on the MBMS user plane.

To sum up, an MBMS control plane may be established between a first base station and a second base station such that the second base station receives MBMS control signals from the core network through the first base station and performs, according to the MBMS control signal, all of the operation(s) required for receiving MBMS data from the core network. Afterwards, an MBMS user plane may be established between the first base station and the second base station or between the core network and the second base station such that the second base station receives the MBMS data through the first base station or directly receives the MBMS data from the core network. Thereby, both of the first base station (such as the base station of 4th generation mobile communication systems (eNodeB)) and the second base station (such as the base station of 5th generation mobile communication systems (gNodeB)) can provide MBMS. Namely, the invention enables the non-standalone 5th generation wireless communication systems to provide the MBMS. Also, because no significant change is made to the architecture of the mobile communication system of the first base station but establishing the MBMS control plane and the MBMS user plane, the design complexity of non-standalone 5th generation wireless communication systems can be reduced effectively.

The aforesaid content is not intended to limit the present invention, but merely describes the technical problems that can be solved by the present invention, the technical means that can be adopted, and the technical effects that can be achieved, so that people having ordinary skill in the art can basically understand the present invention. People having ordinary skill in the art can understand the various embodiments of the present invention according to the attached figures and the content recited in the following embodiments.

### BRIEF DESCRIPTION OF THE DRAWINGS

FIG. 1 illustrates a schematic view of a communication system according to one or more embodiments of the present invention;

FIG. 2A illustrates a schematic view of how the communication system shown in FIG. 1 provides multimedia broadcast/multicast service according to one or more embodiments of the present invention;

FIG. 2B illustrates another schematic view of how the communication system shown in FIG. 1 provides multimedia broadcast/multicast service according to one or more embodiments of the present invention; and

FIG. 3 illustrates a schematic view of a method of providing multimedia broadcast/multicast service according to one or more embodiments of the present invention.

### DETAILED DESCRIPTION

The exemplary embodiments described below are not intended to limit the present invention to any specific environment, applications, structures, examples, embodiments, processes or steps as described in these embodiments. In the attached figures, elements not directly related to the present invention are omitted from depiction. In the attached figures, dimensional relationships among individual elements in the attached drawings are merely examples but not to limit the actual scale. Unless otherwise described, the same (or similar) element symbols may correspond to the same (or similar) elements in the following description. Unless otherwise described, the number of each element described below may be one or more under implementable circumstances.

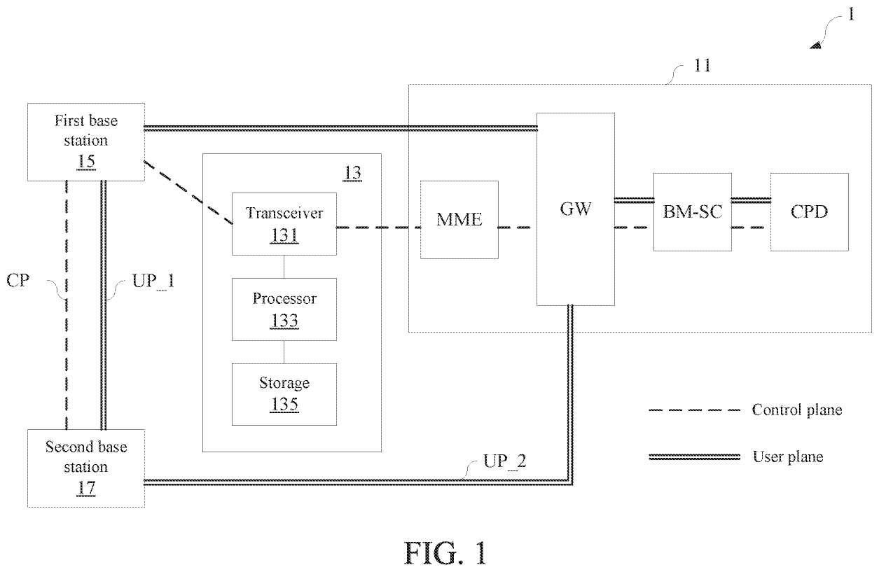

FIG. 1 illustrates a schematic view of a communication system according to one or more embodiments of the present invention. However, contents shown in FIG. 1 are merely for explaining the embodiments of the present invention, but not to limit the present invention.

Referring to FIG. 1, a communication system 1 basically may include a core network 11, a multimedia broadcast/multicast service (MBMS) coordination entity 13, a first base station 15 and a second base station 17. The MBMS coordination entity 13 may be coupled to the core network 11 and the first base station 15, respectively. The MBMS coordination entity 13 may also be known as a multi-cell/multicast coordination entity (MCE).

The core network 11 may include a content provider CPD, a broadcast-multicast service center BM-SC, an MBMS gateway GW and a mobility management entity MME. The content provider CPD may be coupled with the broadcast-multicast service center BM-SC, and there may be a control plane for transmitting control signals and a user plane for transmitting data between the content provider CPD and the broadcast-multicast service center BM-SC. The broadcast-multicast service center BM-SC may be coupled with the MBMS gateway GW, and there may be a control plane for transmitting control signals and a user plane for transmitting data between the broadcast-multicast service center BM-SC and the MBMS gateway GW. The MBMS gateway GW may be coupled with the mobility management entity MME, and there may be a control plane for transmitting control signals between the MBMS gateway GW and the mobility management entity MME. The MBMS gateway GW may be coupled with the first base station 15, and there may be a user plane for transmitting data between the MBMS gateway GW and the first base station 15.

The content provider CPD may provide data related to the MBMS (e.g., MBMS data) and transmit control signals related to the MBMS (e.g., MBMS control signal). The broadcast-multicast service center BM-SC may manage MBMS control signals and the MBMS data coming from the content provider CPD, and perform corresponding operations via the MBMS gateway GW. For example, the MBMS gateway GW may be configured to transmit, via the mobility management entity MME and the MBMS coordination entity 13, the MBMS control signals to the first base station 15 according to the command(s) of the broadcast-multicast service center BM-SC, and then transmit the MBMS data to the first base station 15 so that the first base station 15 provides MBMS for user equipments.

The first base station 15 and the second base station 17 may be base stations of different mobile communication generations. For example, in some embodiments, the core network 11 may be an evolved packet core network (EPC network) in the 4th-generation mobile communications (including the Long-Term Evolution (LTE) system and the LTE Advanced (LTE-A) system). In this situation, the first base station 15 may be a base station of the 4th generation mobile communication system (eNodeB), and the second base station 17 may be a base station of different mobile communication generation (such as a base station of the 5th generation mobile communication system (gNodeB)). For another example, in some embodiments, the core network 11 may be a core network in the 5th generation mobile communication system. In this situation, the first base station 15 may be a base station of the 5th generation mobile communication system (gNodeB), and the second base station 17 may be a base station of different mobile communication generation (such as a base station of the 4th generation mobile communication system (eNodeB)).

Basically, the MBMS coordination entity 13 may comprise a transceiver 131, a processor 133 and a storage 135, wherein the processor 133 is electrically connected to the transceiver 131 and the storage 135, respectively. The processor 133 may be electrically connected to the transceiver 131 and the storage 135 without connecting through other elements (namely electrically connected to each other directly), respectively. The processor 133 may alternatively be electrically connected to the transceiver 131 and the storage 135 through other elements (namely electrically connected to each other indirectly), respectively.

The transceiver 131 may be composed of a transmitter and a receiver and may be, for example but not limited to, a gigabit Ethernet transceiver, a Gigabit Interface Converter (GBIC), a Small form-factor pluggable (SFP) transceiver, a Ten Gigabit Small Form Factor Pluggable (XFP) transceiver, etc.

The processor 133 may be a microprocessor or a microcontroller capable of signal processing. The microprocessor (or the microcontroller) is a programmable specific integrated circuit which is capable of operating, storing, outputting/inputting, etc., and may receive and process various coding instructions, thereby performing various logical operations and arithmetic operations, and outputting corresponding operational results. The processor 133 may be programmed to execute various operations or programs in the MBMS coordination entity 13.

The storage 135 may comprise a first-level memory (also known as a main memory or internal memory), and the processor 133 can read the instruction set stored in the first-level memory directly, and then execute the instruction set as needed. The storage 135 may comprise a second-level memory (also known as an external memory or auxiliary memory) for transmitting the data stored therein to the first-level memory through the data buffer. For example, the second-level memory may be, but not limited to: a hard disk drive, CD, etc. The storage device 135 may comprise a third-level memory, that is, a directly plug-and-play storage device, such as a portable hard disk drive.

The transceiver 131 may be coupled to the core network 11 and the first base station 15, respectively. Besides, there is a control plane for transmitting the MBMS control signals between the transceiver 131 and the mobility management entity MME of the core network 11, and there is a control plane for transmitting the MBMS control signals between the transceiver 131 and the first base station 15.

The processor 133 may be configured to command the first base station 15 and the second base station 17 to establish an MBMS control plane CP such that the second base station 17 may receive the MBMS control signals from the core network 11 on the MBMS control plane CP. Moreover, the processor 133 may be further configured to command the first base station 15 and the second base station 17 to establish an MBMS user plane UP_1 or command the second base station 17 to establish an MBMS user plane UP_2 with the core network 11, such that the second base station 17 receives MBMS data from the core network 11 on the MBMS user plane UP_1 through the first base station 15, or the second base station 17 receives the MBMS data from the core network 11 on the MBMS user plane UP_2 directly.

In some embodiments, the MBMS coordination entity 13 may be a standalone device for use of coordinating MBMS as described above. In some embodiments, the MBMS coordination entity 13 may be configured in any base station other than the second base station 17 (such as the first base station 15). Under such circumstances, the MBMS coordination entity 13 may be a part of any one of the base stations mentioned above, and the MBMS coordination entity 13 and the any one of the base stations may share the transceiver 131, the processor 133 and the storage 135 with each other.

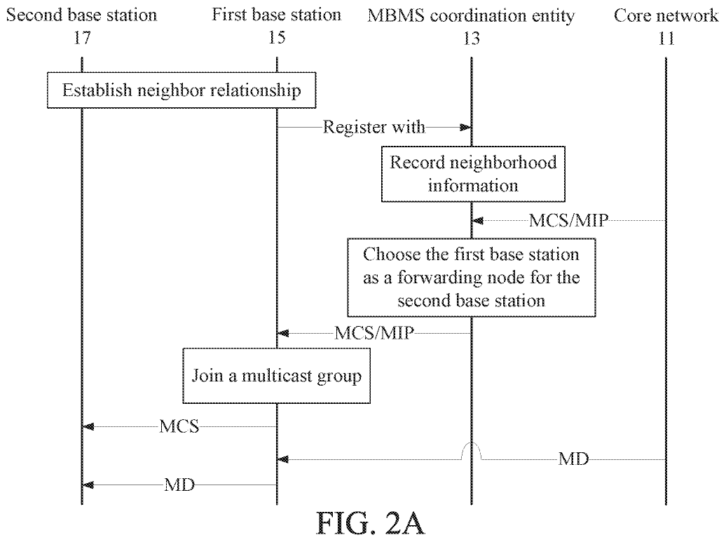

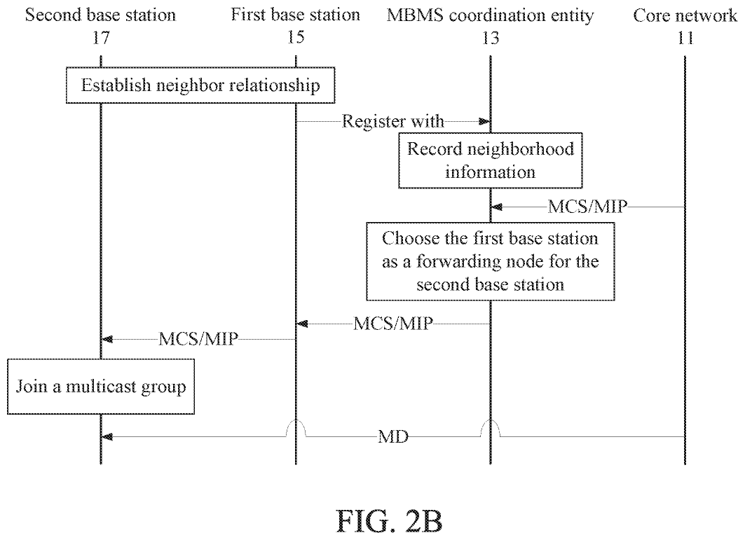

FIG. 2A illustrates a schematic view of how the communication system shown in FIG. 1 provides multimedia broadcast/multicast service (MBMS) according to one or more embodiments of the present invention. Nevertheless, contents shown in FIG. 2A are merely for explaining the embodiments of the present invention, but not to limit the present invention.

Referring to FIG. 1 and FIG. 2A, a plurality of base stations in the communication system 1, including the first base station 15 and the second base station 17, may establish a neighborhood relationship therebetween. When one base station establishes a neighborhood relationship with another base station, it means that these two base stations are neighbors. Furthermore, one or more base stations of the plurality of base stations may register its/their neighborhood relationship(s) established by itself/themselves to the MBMS coordination entity 13 such that and the storage 135 of the MBMS coordination entity 13 stores the neighborhood information of base stations related to the plurality of base stations.

When the transceiver 131 of the MBMS coordination entity 13 receives an MBMS control signal MCS (such as a session-start request signal carrying a multicast network protocol address MIP) from the core network 11, the processor 133 of the MBMS coordination entity 13 may choose the first base station 15 and the second base station 17 according to the neighborhood information of base stations stored in the storage 135. More specifically, the processor 133 of the MBMS coordination entity 13 may recognize that the first base station 15 and the second base station 17 are neighbors according to the neighborhood information of base stations stored in the storage 135, and choose the first base station 15 as a forwarding node for the second base station 17. Then, the transceiver 131 of the MBMS coordination entity 13 may transmit an MBMS control signal MCS (such as a session-start request signal carrying a multicast network protocol address MIP) to the first base station 15.

The first base station 15 may join a multicast group according to the multicast network protocol address MIP after receiving the MBMS control signal MCS, such that the core network 11 transmits MBMS data MD, by multicasting, to the first base station 15 that has joined the multicast group. Therefore, the first base station 15 may provide the MBMS data MD to the user equipments for which the first base station 15 serves.

The first base station 15 may further establish an MBMS control plane CP between itself and the second base station 17 after receiving the MBMS control signal MCS, and may transmit a control signal MCS (such as a session-start request signal without carrying the multicast network protocol address MIP) to the second base station 17 on the MBMS control plane CP, such that the first base station 15 commands the second base station 17 to perform the operations required for receiving MBMS data MD. In addition, the first base station 15 may establish an MBMS user plane UP_1 between itself and the second base station 17.

After establishing the MBMS user plane UP_1, the first base station 15 may forward the MBMS data MD received from the core network 11 to the second base station 17 by using various casting ways, for example, but not limit to unicasting. Thereby, the second base station 17 may provide the MBMS data MD to the user equipments for which the second base station 17 serves.

In some embodiments, the second base station 17 may transmit a response signal (such as a session-start response signal) to the core network 11 through the first base station 15 and the MBMS coordination entity 13 after performing the operations required for receiving the MBMS data MD. After receiving the response signal, the core network 11 transmits the MBMS data MD, by multicasting, to the first base station 15 that has joined the multicast group.

FIG. 2B illustrates another schematic view of how the communication system shown in FIG. 1 provides multimedia broadcast/multicast service (MBMS) according to one or more embodiments of the present invention. However, contents shown in FIG. 2B are merely for explaining the embodiments of the present invention, but not to limit the present invention.

Referring to FIG. 1 and FIG. 2B, the plurality of base stations of the communication system 1, including the first base station 15 and the second base station 17, may establish a neighborhood relationship therebetween. When one base station establishes the neighborhood relationship with another base station, it means that these two base stations are neighbors. Furthermore, one or more base stations of the plurality of base stations may register its/their neighborhood relationship(s) established by itself/themselves to the MBMS coordination entity 13 such that and the storage 135 of the MBMS coordination entity 13 may store neighborhood information of base stations related to the plurality of base stations.

When the transceiver 131 of the MBMS coordination entity 13 receives an MBMS control signal MCS (such as a session-start request signal carrying a multicast network protocol address MIP) from the core network 11, the processor 133 of the MBMS coordination entity 13 may choose the first base station 15 and the second base station 17 according to the neighborhood information of base stations stored in the storage 135. More specifically, the processor 133 of the MBMS coordination entity 13 may recognize that the first base station 15 and the second base station 17 are neighbors according to the neighborhood information of base stations stored in the storage 135, and choose the first base station 15 as a forwarding node for the second base station 17. Then, the transceiver 131 of the MBMS coordination entity 13 may transmit an MBMS control signal MCS (such as a session-start request signal carrying a multicast network protocol address MIP) to the first base station 15.

The first base station 15 may further establish an MBMS control plane CP between itself and the second base station 17 after receiving the MBMS control signal MCS, and may transmit a control signal MCS (such as a session-start request signal carrying the multicast network protocol address MIP) to the second base station 17 on the MBMS control plane CP, such that the first base station 15 commands the second base station 17 to perform the operations required for receiving MBMS data MD. The second base station 17 may join a multicast group according to the multicast network protocol address MIP so that the second base station 17 establishes an MBMS user plane UP_2 between itself and the MBMS gateway GW of the core network 11.

The core network 11 may directly transmit the MBMS data MD, by multicasting, to the second base station 17 that has joined the multicast group on the MBMS user plane UP_2 after establishing the MBMS user plane UP_2. Thereby, the second base station 17 may provide the MBMS data MD received from the core network 11 to the user equipments for which the second base station 17 serves.

In some embodiments, the first base station 15 may join the multicast group according to the multicast network protocol address MIP after receiving the MBMS control signal MCS, such that the core network 11 may transmit the MBMS data MD, by multicasting, to the first base station 15 that has joined the multicast group. Thereby, the first base station 15 may provide the MBMS data MD to the user equipments for which the first base station 15 serves.

In some embodiments, the second base station 17 may transmit a response signal (such as a session-start response signal) to the core network 11 through the first base station 15 and the MBMS coordination entity 13 after performing the operations required for receiving the MBMS data MD. The core network 11 may transmit the MBMS data MD, by multicasting, to the first base station 15 or/and the second base station 17 that has/have joined the multicast group after receiving the response signal.

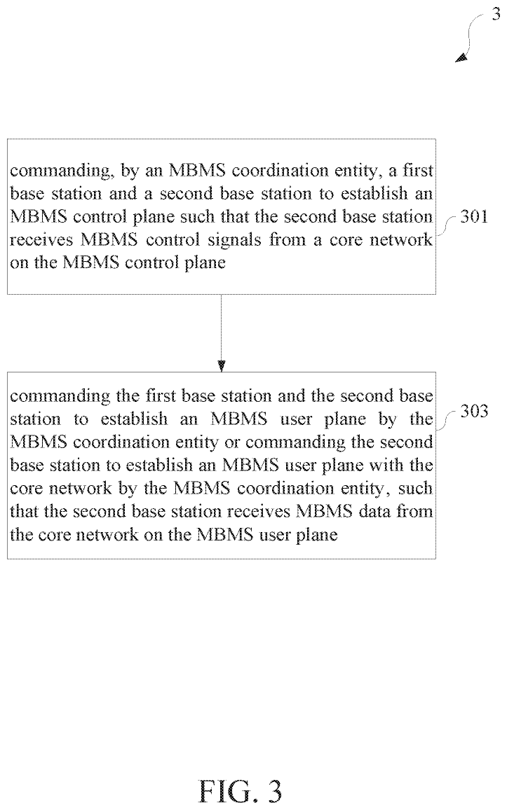

FIG. 3 illustrates a schematic view of a method of providing multimedia broadcast/multicast service (MBMS) according to one or more embodiments of the present invention. However, the content shown in FIG. 3 are merely for explaining the embodiments of the present invention, but not to limit the present invention.

Referring to FIG. 3, a method 3 of providing multimedia broadcast/multicast service may comprise the following steps:

commanding, by an MBMS coordination entity, a first base station and a second base station to establish an MBMS control plane such that the second base station receives MBMS control signals from a core network on the MBMS control plane (marked as step 301); and

commanding the first base station and the second base station to establish an MBMS user plane by the MBMS coordination entity or commanding the second base station to establish an MBMS user plane with the core network by the MBMS coordination entity, such that the second base station receives MBMS data from the core network on the MBMS user plane (marked as step 303).

In some embodiments, the method 3 of providing multimedia broadcast/multicast service may further comprise the following steps:

forwarding, by the MBMS coordination entity, a multicast internet protocol address received from the core network to the first base station;

joining, by the first base station, a multicast group according to the multicast internet protocol address;

transmitting, by the core network, the MBMS data to the first base station that has joined the multicast group; and

forwarding, by the first base station, the MBMS data to the second base station on the MBMS user plane.

In some embodiments, the method 3 of providing multimedia broadcast/multicast service may further comprise the following steps:

forwarding, by the MBMS coordination entity, a multicast internet protocol address received from the core network to the first base station;

forwarding, by the first base station, the multicast internet protocol address to the second base station on the MBMS control plane;

joining, by the second base station, a multicast group according to the multicast internet protocol address; and

transmitting, by the core network, the MBMS data to the second base station that joined the multicast group on the MBMS user plane.

In some embodiments, the method 3 of providing multimedia broadcast/multicast service may further comprise the following steps:

storing, by the MBMS coordination entity, neighborhood information of base stations; and

choosing, by the MBMS coordination entity, the first base station and the second base station according to the neighborhood information of base stations.

In some embodiments, the first base station and the second base station in the method 3 of providing multimedia broadcast/multicast service may be base stations of different mobile communication generations.

In addition to the aforesaid steps, in some embodiments, the method 3 of providing multimedia broadcast/multicast service may further comprise other steps corresponding to the operations of the communication system 1 as mentioned above. These steps which are not mentioned specifically can be directly understood by people having ordinary skill in the art based on the aforesaid descriptions for the communication system 1, and will not be further described herein.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A communication system in support of multimedia broadcast/multicast service (MBMS), comprising:
a core network;
an MBMS coordination entity coupled to the core network;
a first base station coupled to the MBMS coordination entity; and
a second base station;
wherein the MBMS coordination entity is configured to command the first base station and the second base station to establish an MBMS control plane such that the second base station receives MBMS control signals from the core network on the MBMS control plane; and
wherein the MBMS coordination entity is also configured to command the first base station and the second base station to establish an MBMS user plane or command the second base station to establish an MBMS user plane with the core network, such that the second base station receives MBMS data from the core network on the user plane.

2. The communication system of claim 1, wherein:
the MBMS coordination entity is configured to forward a multicast internet protocol address received from the core network to the first base station;
the first base station is configured to join a multicast group according to the multicast internet protocol address;
the core network is configured to transmit the MBMS data to the first base station that has joined the multicast group; and
the first base station is configured to forward the MBMS data to the second base station on the MBMS user plane.

3. The communication system of claim 1, wherein:
the MBMS coordination entity is configured to forward a multicast internet protocol address received from the core network to the first base station;
the first base station is configured to forward the multicast internet protocol address to the second base station on the MBMS control plane;
the second base station is configured to join a multicast group according to the internet protocol address; and
the core network is configured to transmit the MBMS data to the second base station that has joined the multicast group on the MBMS user plane.

4. The communication system of claim 1, wherein the MBMS coordination entity is configured to store neighborhood information of base stations and choose the first base station and the second base station according to the neighborhood information of base stations.

5. The communication system of claim 1, wherein the first base station and the second base station are base stations of different mobile communication generations.

6. A method of providing multimedia broadcast/multicast service (MBMS), comprising:
commanding, by an MBMS coordination entity, a first base station and a second base station to establish an MBMS control plane such that the second base station receives MBMS control signals from a core network on the MBMS control plane; and
commanding the first base station and the second base station to establish an MBMS user plane by the MBMS coordination entity or commanding the second base station to establish an MBMS user plane with the core network by the MBMS coordination entity, such that the second base station receives MBMS data from the core network on the MBMS user plane.

7. The method of claim 6, further comprising:
forwarding, by the MBMS coordination entity, a multicast internet protocol address received from the core network to the first base station;
joining, by the first base station, a multicast group according to the multicast internet protocol address;
transmitting, by the core network, the MBMS data to the first base station that has joined the multicast group; and
forwarding, by the first base station, the MBMS data to the second base station on the MBMS user plane.

8. The method of claim 6, further comprising:
forwarding, by the MBMS coordination entity, a multicast internet protocol address received from the core network to the first base station;
forwarding, by the first base station, the multicast internet protocol address to the second base station on the MBMS control plane;
joining, by the second base station, a multicast group according to the multicast internet protocol address; and
transmitting, by the core network, the MBMS data to the second base station that joined the multicast group on the MBMS user plane.

9. The method of claim 6, further comprising:
storing, by the MBMS coordination entity, neighborhood information of base stations; and
choosing, by the MBMS coordination entity, the first base station and the second base station according to the neighborhood information of base stations.

10. The method of claim 6, wherein the first base station and the second base station are base stations of different mobile communication generations.

11. A multimedia broadcast/multicast service (MBMS) coordination entity, comprising:
a transmitter coupled to a core network and a first base station; and
a processor electrically connected to the transmitter, configured to:
command the first base station and a second base station to establish an MBMS control plane such that the second base station receives MBMS control signals from the core network on the MBMS control plane; and
command the first base station and the second base station to establish an MBMS user plane or command the second base station to establish an MBMS user plane with the core network, such that the second base station receives MBMS data from the core network on the MBMS user plane.

12. The MBMS coordination entity of claim 11, wherein:
the transmitter is further configured to forward a multicast internet protocol address received from the core network to the first base station; and
the processor is further configured to command that the first base station joins a multicast group according to the multicast internet protocol address, such that the core network transmits the MBMS data to the first base station that has joined the multicast group and the first base station forwards the MBMS data to the second base station on the MBMS user plane.

13. The MBMS coordination entity of claim 11, wherein:
the transmitter is further configured to forward a multicast internet protocol address received from the core network to the first base station; and
the processor is further configured to command the first base station to forward the multicast internet protocol address to the second base station and to command that the second base station joins a multicast group according to the multicast internet protocol address, such that the core network transmits the MBMS data to the second base station that has joined the multicast group on the MBMS user plane.

14. The MBMS coordination entity of claim 11, further comprising a storage electrically connected to the processor, wherein:
the storage is configured to store neighborhood information of base stations; and
the processor is further configured to choose the first base station and the second base station according to the neighborhood information of base stations.

15. The MBMS coordination entity of claim 11, wherein the first base station and the second base station are base stations of different mobile communication generations.
